(19) United States
(12) Patent Application Publication
(10) Pub. No.: US 2011/0173400 A1
(43) Pub. Date: Jul. 14, 2011

(54) BUFFER MEMORY DEVICE, MEMORY SYSTEM, AND DATA TRANSFER METHOD

(75) Inventor: Takanori ISONO, Kyoto (JP)

(73) Assignee: PANASONIC CORPORATION, Osaka (JP)

(21) Appl. No.: 13/069,854

(22) Filed: Mar. 23, 2011

Related U.S. Application Data
(63) Continuation of application No. PCT/JP2009/004603, filed on Sep. 15, 2009.

(30) Foreign Application Priority Data
Sep. 25, 2008 (JP) 2008-246584

(51) Int. Cl. G06F 12/00

(52) U.S. Cl. 711/154; 711/E12.001

(57) ABSTRACT

This invention may be applied for performing a burst write of write data, and increases efficiency of data transfer to memory. A buffer memory device transfers data between processors and a main memory in response to a memory access request issued by each of the processors. The buffer memory device includes: buffer memories each of which holds write data corresponding to the write request issued by a corresponding processor; a memory access information obtaining unit which obtains memory access information indicating a type of the memory access request; a determining unit which determines whether or not the type indicated by the memory access information obtained by the memory access information obtaining unit meets a predetermined condition; and a control unit which drains, to the main memory, data held in one of the buffer memories which meets the predetermined condition, when determined that the predetermined condition is met.

### CROSS REFERENCE TO RELATED APPLICATION

This is a continuation application of PCT application No. PCT/JP2009/004603 filed on Sep. 15, 2009, designating the United States of America.

### BACKGROUND OF THE INVENTION

(1) Field of the Invention

The present invention relates to buffer memory devices, memory systems, and data transfer methods, and in particular, to a buffer memory device, a memory system, and a data transfer method which temporarily hold, in a buffer memory, data output from a processor and drain the data to a main memory.

(2) Description of the Related Art

In recent years, in order to accelerate memory access from a microprocessor to a main memory, small and fast cache memories are used which are, for example, Static Random Access Memory (SRAM). It is possible to accelerate memory access by, for example, providing a cache memory inside or near a microprocessor and storing, in the cache memory, part of the data held in the main memory.

There is a conventional technique where a cache memory includes a store buffer (STB) that is an example of a buffer memory for temporarily holding write data (see Japanese Patent Application Publication No. 2006-260159, hereinafter referred to as Patent Document 1).

FIG. 18 is a block diagram schematically illustrating a conventional memory system. The memory system shown in FIG. 18 includes a processor 310, a main memory 320, and a cache 330. The cache 330 includes an STB 331.

In the conventional memory system shown in FIG. 18, when performing write processing of write data to continuous addresses, the cache 330 merges write data sent from the processor 310 and temporarily holds the data in the STB 331. The cache 330 then performs a burst write of the held data into the main memory 320.

For example, it is assumed that the data bus width between the main memory 320 and the cache 330 is 128 bytes. Here, a description is given of the case where the processor 310 performs write processing of a plurality of pieces of 4-byte write data to continuous areas indicated by continuous addresses in the main memory 320. The cache 330 merges the respective 4-byte write data and holds the data in the STB 331. When the size of the data held in the STB 331 reaches 128 bytes, the cache 330 performs a burst write of the 128-byte data to the main memory 320.

In such a manner, in the conventional memory system, small-size write data is merged and temporarily held, and the large-size data obtained by the merge is burst written to the main memory. This allows efficient use of the data bus or the like, leading to increased efficiency of data transfer to memory.

### SUMMARY OF THE INVENTION

However, the following problems exist in the conventional technique.

In the case where there are a plurality of masters which issue write requests, such as threads and processors, and write data from the masters are held to be merged. More specifically, in the case of multi-master, such as multi-thread and multi-processor, it is difficult to manage the master which issued the write request for write data held in the buffer memory. Furthermore, when the same thread is executed by different masters, data coherency cannot be maintained.

As described, the problem exists where the conventional memory system cannot be applied to the case where write data corresponding to write requests issued by a plurality of masters are merged and the merged write data is burst transferred.

The present invention has been conceived to solve the problem, and has an object to provide a buffer memory device, a memory system, and a data transfer method which can be applied to the case where a plurality of pieces of write data is burst written, and which increases efficiency of data transfer.

In order to solve the problem, a buffer memory device according to an aspect of the present invention is a buffer memory device which transfers data between a plurality of processors and a main memory in response to a memory access request including a write request or a read request issued by each of the processors. The buffer memory device includes: a plurality of buffer memories each of which is provided for a corresponding one of the processors, and holds write data corresponding to the write request issued by the corresponding one of the processors; a memory access information obtaining unit which obtains memory access information indicating a type of the memory access request; a determining unit which determines whether or not the type indicated by the memory access information obtained by the memory access information obtaining unit meets a predetermined condition; and a control unit which drains data held in a buffer memory to the main memory, when the determining unit determines that the type indicated by the memory access information meets the predetermined condition, the buffer memory being included in the buffer memories and meeting the predetermined condition.

By providing a buffer memory for each of processors, and controlling the drain of data from the buffer memory based on one or more predetermined conditions, it is possible to facilitate the management of write data output from the processors, for example, maintaining of data coherency. Furthermore, it is possible to increase efficiency of data transfer.

More specifically, the buffer memory device according to an aspect of the present invention has a function to merge write data, and includes a buffer memory for performing the merge. By performing a burst transfer of the merged data to the buffer memory, it is possible to increase efficiency of data transfer. Here, a condition is predetermined for determining when data is drained from the buffer memory; and thus, data drain can be executed as necessary or to maintain coherency. As a result, efficiency of data transfer can be increased.

It may also be that the processors are a plurality of physical processors, each of the buffer memories is provided for a corresponding one of the physical processors, and holds write data corresponding to the write request issued by the corresponding one of the physical processors, the memory access information obtaining unit obtains, as the memory access information, processor information indicating a logical processor and a physical processor which have issued the memory access request, the determining unit determines that the predetermined condition is met, in the case where one of the buffer memories holds write data corresponding to a write request previously issued by (i) a physical processor that is different from the physical processor indicated by the processor information and (ii) a logical processor that is same as the logical processor indicated by the processor information, and when the determining unit determines that the predetermined condition is met, the control unit drains, to the main memory, the data held in the buffer memory which meets the predetermined condition.

Accordingly, in the case where access requests are issued by different physical processors and the same logical processor, data coherency can be maintained by writing, to the main memory, data corresponding to a previously issued write request. In the case where memory access requests are issued by a same logical processor but different physical processors, data output by the same logical processor may be held in different buffer memories. When it happens, data coherency cannot be maintained between respective buffer memories. By draining the data held in the buffer memory to the main memory, it is possible to overcome the problem of the data coherency between the buffer memories.

It may also be that the determining unit further determines whether or not the memory access information includes command information for draining, to the main memory, data held in at least one of the buffer memories, when the determining unit determines that the memory access information includes the command information, the control unit further drains, to the main memory, the data indicated by the command information and held in the at least one of the buffer memories.

Accordingly, it is possible to easily drain data held in the buffer memory to the main memory, based on an instruction from the processor, thereby updating the data in the main memory.

It may also be that the command information is information for draining, to the main memory, data held in all of the buffer memories, and when the determining unit determines that the memory access information includes the command information, the control unit further drains, to the main memory, the data held in all of the buffer memories.

Accordingly, data in all of the buffer memories can be drained to the main memory, thereby updating all of the data in the main memory.

It may also be that when the determining unit determines that the memory access information includes the command information, the control unit further drains, to the main memory, data held in one of the buffer memories corresponding to a processor which has issued the memory access request.

Accordingly, it is possible to designate only a given buffer memory to drain the data held in the buffer memory. Thus, it is possible to store the data that is to be subsequently read by the processor, not in the buffer memory but in the main memory.

It may also be that the main memory includes a plurality of areas each having either a cacheable attribute or an uncacheable attribute, the memory access information obtaining unit further obtains, as the memory access information, attribute information and processor information, the attribute information indicating an attribute of an area indicated by an address included in the memory access request, the processor information indicating a processor which has issued the memory access request, the determining unit further determines whether or not the attribute indicated by the attribute information is the uncacheable attribute and a non-burst-transferable attribute which indicates that data to be burst transferred is to be held, and when the determining unit determines that the attribute indicated by the attribute information is the non-burst-transferable attribute, the control unit further drains, to the main memory, data held in one of the buffer memories corresponding to the processor indicated by the processor information.

This maintains the order of the write requests issued by the processor. As a result, data coherency can be maintained.

It may also be that the buffer memories hold a write address corresponding to the write data, when the memory access request includes the read request, the memory access information obtaining unit further obtains, as the memory access information, a read address included in the read request, the determining unit determines whether or not a write address which matches the read address is held in at least one of the buffer memories, and when the determining unit determines that the write address which matches the read address is held in the at least one of the buffer memories, the control unit drains, to the main memory, data held in the buffer memories prior to the write data corresponding to the write address.

According to this structure, data in the area indicated by the read address can always be updated before the data is read from the area; and thus, it is possible to prevent old data from being read by the processor.

It may also be that when the memory access request includes the write request, the memory access information obtaining unit further obtains a first write address included in the write request, the determining unit determines whether or not the first write address is continuous with a second write address included in an immediately prior write request, and when the determining unit determines that the first write address is continuous with the second write address, the control unit drains, to the main memory, data held in the buffer memories prior to write data corresponding to the second write address.

Generally, when a processor performs a sequence of processing, the processor often access continuous areas indicated by continuous addresses; and thus, when the addresses are not continuous, it can be assumed that different processing has started. Therefore, data related to the sequence of processing is drained to the main memory. Accordingly, the data related to other processing can be held in the buffer memory, which allows efficient use of the buffer memory.

It may also be that the determining unit further determines whether or not an amount of data held in each of the buffer memories reaches a predetermined threshold, and when the determining unit determines that the data amount reaches the predetermined threshold, the control unit further drains, to the main memory, the data held in the buffer memory having the data amount which reaches the predetermined threshold.

Accordingly, when the amount of data in the buffer memory reaches an adequate amount, the data can be drained. For example, data can be drained when the data amount is equivalent to the maximum data amount that can be held in the buffer memory or, to the data bus width between the buffer memory and the main memory.

It may also be that the main memory includes a plurality of areas each having either a cacheable attribute or an uncacheable attribute, the buffer memory device further includes a data writing unit which writes, to the buffer memories, write data corresponding to the write request, when the attribute of the area indicated by the write address included in the write request is the uncacheable attribute and a non-burst-transferable attribute which indicates that data to be burst transferred is to be held, and the buffer memories hold the write data written by the data writing unit.

Accordingly, the buffer memory can be used for writing data into the area which allows burst transfer. More specifically, it is possible to change whether or not the buffer memory is used, depending on the attribute of the area of the main memory. As a result, it is possible to efficiently use the buffer memory.

It may also be that the buffer memory device further includes a cache memory, wherein (i) when the attribute of the area indicated by the write address is the cacheable attribute and (ii) when the write data corresponding to the write request is written to the cache memory and the main memory at the same time, the data writing unit further writes the write data corresponding to the write request to the buffer memories, and when the determining unit determines that the predetermined condition is met, the control unit drains the data held in the buffer memory which meets the predetermined condition to the main memory and the cache memory.

Accordingly, the buffer memory can also be used when writing write data to the cache memory and the main memory at the same time (write-through operation). This allows a burst write of data from the buffer memory to the cache memory.

It may also be that at least one of the buffer memories holds write addresses included in a plurality of the write requests, and write data corresponding to the respective write requests.

Accordingly, it is possible to store, in the buffer memory, a plurality pieces of write data in association with a plurality of write addresses; and thus, it is possible to manage the write data and also to collectively drain the plurality of pieces of write data to the main memory.

It may also be that the processors are a plurality of logical processors, and each of the buffer memories is provided for a corresponding one of the logical processors, and holds write data corresponding to the write request issued by the corresponding one of the logical processors.

It may also be that the processors are a plurality of virtual processors corresponding to respective threads, and each of the buffer memories is provided for a corresponding one of the virtual processors and holds write data corresponding to the write request issued by the corresponding one of the virtual processors.

Accordingly, it is possible to easily manage write data.

The present invention may be also implemented as a memory system including the buffer memory device, a plurality of processors, and a main memory.

The present invention may also be implemented as a data transfer method. The data transfer method according to an aspect of the present invention is a method of transferring data between a plurality of processors and a main memory in response to a memory access request issued by each of the processors, the memory access request including a write request and a read request. The method includes: obtaining memory access information indicating a type of the memory access request issued by each of the processors; determining whether or not the type indicated by the memory access information obtained in the obtaining meets a predetermined condition; and when determined in the determining that the type indicated by the memory access information meets the predetermined condition, draining, to the main memory, data held in a buffer memory that meets the predetermined condition, the buffer memory being included in a plurality of buffer memories each of which is provided for a corresponding one of the processors and holds write data corresponding to the write request issued by the corresponding one of the processors.

It may also be that the present invention is implemented as a program causing a computer to execute the steps included in the data transfer method. Furthermore, the present invention may also be implemented as a recording medium such as a computer-readable Compact Disc-Read Only Memory (CD-ROM) storing the programs, and as information, data or signals indicating the programs. Such program, information and signals may be distributed over communications network such as the Internet.

According to the buffer memory device, the memory system, and the data transfer method in the present invention, write data output from a plurality of masters can be burst written, which allows increased efficiency of data transfer to memory.

### FURTHER INFORMATION ABOUT TECHNICAL BACKGROUND TO THIS APPLICATION

The disclosure of Japanese Patent Application No. 2008-246584 filed on Sep. 25, 2008 including specification, drawings and claims is incorporated herein by reference in its entirety.

The disclosure of PCT application No. PCT/JP2009/004603 filed on Sep. 15, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram schematically illustrating a memory system including a processor, a main memory, and caches according to one embodiment of the present invention;

FIG. 2 is a diagram illustrating attributes set to the areas in the main memory according to one embodiment of the present invention;

FIG. 3 is a block diagram illustrating a structure of the buffer memory device according to one embodiment of the present invention;

FIG. 4 is a diagram illustrating an example of memory access information according to the embodiment;

FIG. 5 is a diagram schematically illustrating a buffer memory included in the buffer memory device according to the embodiment of the present invention;

FIG. 6 illustrates a determination table showing an example of determining conditions according to the embodiment;

FIG. 7 is a block diagram illustrating a detailed structure of a determining unit according to the embodiment;

FIG. 8 is a flowchart of operations of the buffer memory device according to the embodiment;

FIG. 9 is a flowchart of write processing of the buffer memory device according to the embodiment;

FIG. 10 is a flowchart of read processing of the buffer memory device according to the embodiment;

FIG. 11 is a flowchart of attribute determination processing of the buffer memory device according to the embodiment;

FIG. 12 is a flowchart of command determination processing of the buffer memory device according to the embodiment;

FIG. 13 is a flowchart of read address determination processing of the buffer memory device according to the embodiment;

FIG. 14 is a flowchart of write address determination processing of the buffer memory device according to the embodiment;

FIG. 15 is a flowchart of buffer amount determination processing of the buffer memory device according to the embodiment;

FIG. 16 is a flowchart of processor determination processing of the buffer memory device according to the embodiment;

FIG. 17 is another diagram schematically illustrating the buffer memory included in the buffer memory device according to the embodiment; and

FIG. 18 is a block diagram schematically illustrating a conventional memory system.

### DESCRIPTION OF THE PREFERRED EMBODIMENT(S)

Hereinafter, reference is made to a buffer memory device, a memory system, and a data transfer method according to the present invention based on one embodiment, with reference to the drawings.

A buffer memory device according to the embodiment temporarily holds data which is output from a processor and which is to be written to the main memory, and performs a burst write of the held data when one or more predetermined conditions are met. Accordingly, data bus can be effectively used, which allows efficient data transfer.

First, reference is made to a general memory system which includes a buffer memory device according to the embodiment.

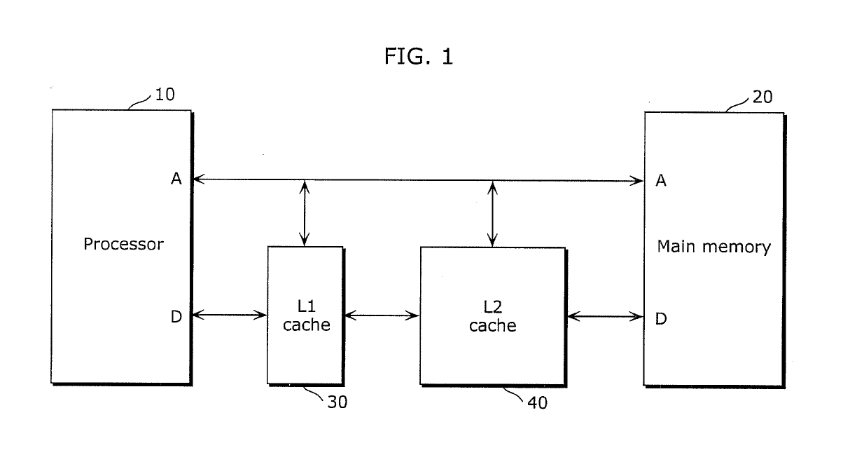

FIG. 1 is a block diagram schematically illustrating a memory system including a processor, a main memory, and cache memories according to the embodiment. As shown in FIG. 1, the memory system according to the embodiment includes a processor 10, a main memory 20, an L1 (level 1) cache 30, and an L2 (level 2) cache 40.

The buffer memory device according to the embodiment is provided, for example, between the processor 10 and the main memory 20 in the system as shown in FIG. 1. More specifically, a buffer memory included in the buffer memory device is included in the L2 cache 40.

The processor 10 issues a memory access request to the main memory 20, and outputs the memory access request. The memory access request is, for example, a read request for reading data, or a write request for writing data. The read request includes a read address indicating the area from which data is to be read. The write request includes a write address indicating the area to which data is to be written. When outputting a write request, the processor 10 also outputs data to be written to the main memory 20 in accordance with the write request.

The main memory 20 includes a plurality of areas each having either a cacheable attribute or an uncacheable attribute. The main memory 20 is a large-capacity main memory, such as a Synchronous Dynamic Random Access Memory (SDRAM), for storing programs, data, and the like in the areas. In response to a memory access request (read request or write request) output from the processor 10, data is read from the main memory 20 or data is written into the main memory 20.

The L1 cache 30 and the L2 cache 40 are cache memories such as an SRAM for storing part of the data read by the processor 10 from the main memory 20 and part of the data to be written by the processor 10 into the main memory 20. The L1 cache 30 and the L2 cache 40 are cache memories which have capacities smaller than that of the main memory 20, but which is capable of operating at a high speed. The L1 cache 30 is a cache memory which has a higher priority and is provided closer to the processor 10 than the L2 cache 40. Generally, the L1 cache 30 has a smaller capacity, but is capable of operating at a higher speed compared to the L2 cache 40.

The L1 cache 30 obtains the memory access request output from the processor 10, and determines whether data corresponding to the address included in the obtained memory access request is already stored (hit) or not stored (miss). For example, when the read request is a hit, the L1 cache 30 reads the data corresponding to the read address included in the read request from inside the L1 cache 30, and outputs the data to the processor 10. The data corresponding to the read address refers to the data stored in the area indicated by the read address. When the write request is a hit, the L1 cache 30 writes the data corresponding to the write request into the L1 cache 30. The data corresponding to the write request refers to the data (hereinafter, may also be referred to as write data) output from the processor 10 at the same time as the write request.

When the read request is a miss, the L1 cache 30 reads data corresponding to the read request from the L2 cache 40 or the main memory 20, and outputs the data to the processor 10. The data corresponding to the read request refers to the data (hereinafter, may also be referred to as read data) held in the area of the main memory 20 indicated by the read address included in the read request. When the write request is a miss, the L1 cache 30 performs refill processing, updates a tag address, and writes the data output from the processor 10 at the same time as the write request.

The L2 cache 40 obtains the memory access request output from the processor 10, and determines whether or not the obtained memory access request is a hit or a miss. When the read request is a hit, the L2 cache 40 reads, from inside the L2 cache 40, the data corresponding to the read address included in the read request, and outputs the data to the processor 10 via the L1 cache 30. When the write request is a hit, the L2 cache writes, into inside the L2 cache 40 via the L1 cache 30, the data corresponding to the write request.

When the read request is a miss, the L2 cache 40 reads the data corresponding to the read request from the main memory 20, and outputs the data to the processor 10 via the L1 cache 30. When the write request is a miss, the L2 cache 40 performs refill processing, updates a tag address and writes the data corresponding to the write request via the L1 cache 30.

In the memory system shown in FIG. 1, processing is performed for maintaining coherency between the main memory 20, the L1 cache 30, and the L2 cache 40. For example, the data written into the cache memory in accordance with a write request is written into the main memory 20 through a write-through operation or a write-back operation. The write-back operation refers to processing where, after data is written to the cache memory, the data is written to the main memory at a given timing. The write-through operation refers to processing where writing of data to the cache memory and writing of the data to the main memory are executed at the same time.

When the write request is a miss, the processor 10 may write data into the main memory 20 without refilling or updating the L1 cache 30. The same also applies to the L2 cache 40.

Although FIG. 1 illustrates the structure where the L1 cache 30 is provided outside the processor 10, the L1 cache 30 may be included in the processor 10.

The data may be transferred to and from, not only the main memory 20, but also another peripheral device such as an input/output (IO) device. The peripheral device refers to a device which transfers data to and from the processor 10, and is, for example, a keyboard, a mouse, a display, or a floppy (registered trademark) disk drive.

Next, reference is made to the main memory 20 according to the embodiment.

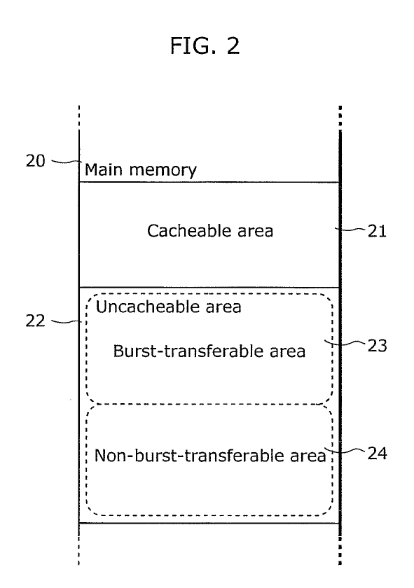

FIG. 2 is a diagram illustrating attributes set in an address space according to the embodiment. The areas of the address space are assigned to the main memory 20, other peripheral devices, and the like. As shown in FIG. 2, the main memory 20 includes a cacheable area 21 and an uncacheable area 22.

The cacheable area 21 is an area having a cacheable attribute which indicates that data to be cached to the cache memories, such as the L1 cache 30 or the L2 cache 40, can be held.

The uncacheable area 22 is an area having an uncacheable attribute which indicates that data that is not to be cached to the cache memories, such as the L1 cache 30 or the L2 cache 40, can be held. The uncacheable area 22 includes a burst-transferable area 23 and a non-burst-transferable area 24.

The burst-transferable area 23 is an area having a burst-transferable attribute which indicates that data, which is not to be cached to the cache memory and which is to be burst transferred, can be held. The burst transfer refers to transferring data collectively, and is, for example, a burst read or a burst write. The burst-transferable area 23 is, for example, an area that is not read-sensitive. The read-sensitive area refers to an area where the value of the held data changes when the data is read.

The non-burst-transferable area 24 is an area having a non-burst-transferable attribute which indicates that data, which is not to be cached to the cache memory and which is to be burst transferred, can not be held. The non-burst-transferable area 24 is, for example, a read-sensitive area.

As described, the main memory 20 according to the embodiment has areas each set to one of the three exclusive attributes. The setting of the attributes of the main memory 20 is performed by, for example, a memory management unit (MMU) included in the processor 10. It may be that the processor 10 includes a translation lookaside buffer (TLB) for storing an address conversion table in which physical addresses and virtual addresses are associated with one another, so that the attributes are stored in the address conversion table.

Next, reference is made to the buffer memory device according to the embodiment.

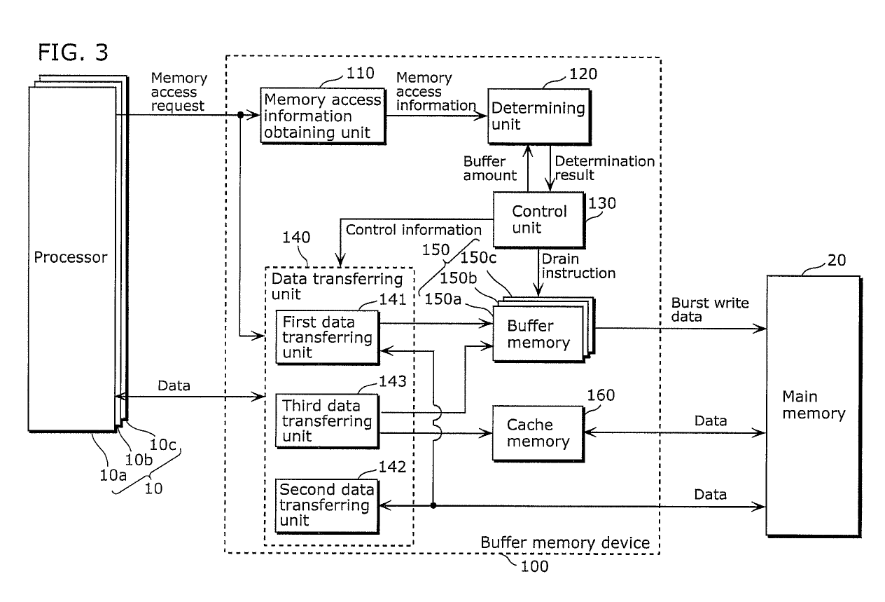

FIG. 3 is a block diagram illustrating a structure of the buffer memory device according to the embodiment. A buffer memory device 100 shown in FIG. 3 transfers data between processors 10a, 10b, and 10c and a main memory 20, in accordance with a memory access request issued by the respective processors 10a, 10b, and 10c. In the following description, when it is not particularly necessary to identify the processor 10a, 10b, or 10c, they are simply referred to as processor 10.

It is assumed that the buffer memory device 100 is provided on the same chip as the L2 cache 40 shown in FIG. 1. It is also assumed that the L1 cache 30 shown in FIG. 1 is provided for each of the processors 10a, 10b, and 10c, and they are not shown in FIG. 3. It may be that the L1 cache 30 is provided between the processors 10a, 10b, and 10c and the buffer memory device 100, and may be commonly used among the processors 10a, 10b and 10c.

As shown in FIG. 3, the buffer memory device 100 includes a memory access information obtaining unit 110, a determining unit 120, a control unit 130, a data transferring unit 140, buffer memories 150a, 150b, and 150c, and a cache memory 160. In the following description, when it is not particularly necessary to identify the buffer memories 150a, 150b, and 150c, they are simply referred to as buffer memory 150.

The memory access information obtaining unit 110 obtains a memory access request from the processor 10, and obtains, from the memory access request, memory access information indicating the type of the memory access request issued by the processor 10. The memory access information is information included in the memory access request or information attached thereto, and includes command information, address information, attribute information, processor information and the like.

The command information is information indicating whether the memory access request is a write request or a read request, and other commands related to data transfer. The address information is information which indicates a write address indicating the area into which data is written or a read address indicating the area from which data is read. The attribute information is information indicating the attribute of the area indicated by the write address or the read address from among cacheable, burst-transferable, and non-burst-transferable attribute. The processor information is information indicating a thread, a logical processor (LP), and a physical processor (PP) which have issued the memory access request.

The attribute information may not be included in the memory access request. In this case, it may be that the memory access information obtaining unit 110 holds a table in which addresses of the main memory 20 are associated with the attributes of the areas indicated by the addresses, and obtains the attribute information with reference to address information and the table.

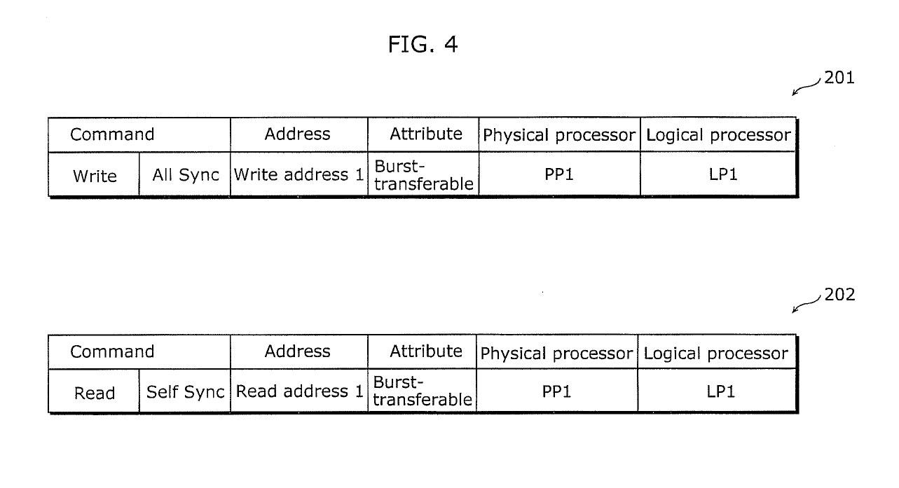

Here, reference is made to FIG. 4. FIG. 4 is a diagram illustrating an example of memory access information according to the embodiment. In FIG. 4, the memory access information 201 and 202 are shown.

The memory access information 201 indicates that a memory access request is a write request issued by the logical processor “LP1” of the physical processor “PP1”, and that the memory access request includes a write command indicating that data is to be written to the burst-transferable area indicated by the “write address 1”. It is also indicated that the write request includes an “All Sync” command.

The memory access information 202 indicates that a memory access request is a read request issued by the logical processor “LP1” of the physical processor “PP1”, and that the memory access request includes a read command indicating that data is to be read from the burst-transferable area indicated by the “read address 1”. It is also indicated that the read request includes a “Self Sync” command.

Detailed descriptions of the “All Sync” and “Self Sync” commands are given later.

Returning to FIG. 3, the determining unit 120 determines whether or not the type of the memory access information obtained by the memory access information obtaining unit 110 meets predetermined conditions. More specifically, the determining unit 120 determines if the conditions are met, by using the command information, attribute information, address information and processor information obtained as the memory access information, and buffer amount information obtained from the buffer memory 150 via the control unit 130. The detailed descriptions of the conditions and processing performed by the determining unit 120 are given later. The buffer amount information is information indicating the amount of data held in each buffer memory 150.

When the determining unit 120 determines that the type indicated by the memory access information meets the conditions, the control unit 130 drains, to the main memory, the data that is held in the buffer memory, among the buffer memories 150a, 150b, and 150c, which meets the conditions. More specifically, the control unit 130 outputs a drain command to the buffer memory 150. The drain command is output to the buffer memory that drains data, and the buffer memory which receives the drain command outputs the held data to the main memory 20.

The control unit 130 controls the data transferring unit 140 by outputting control information to the data transferring unit 140. For example, the control information includes at least attribute information. The control unit 130 determines the write destination of write data, read destination of read data, and the like, in accordance with the attribute of the area indicated by the address.

The control unit 130 outputs, to the determining unit 120, the buffer amount that is an amount of data held in the respective buffer memories 150a, 150b, and 150c.

The data transferring unit 140 transfers data between the processor 10 and the main memory 20 under the control of the control unit 130. More specifically, when a write request is output from the processor 10, the write data output from the processor 10 to be written to the main memory 20 is written to one of the buffer memory 150, the cache memory 160, and the main memory 20. When the read request is output from the processor 10, read data is read from one of the cache memory 160 and the main memory 20, and the read data is output to the processor 10. The used memory is determined by the control unit 130 depending on the attribute of the area indicated by the address.

As shown in FIG. 3, the data transferring unit 140 includes a first data transferring unit 141, a second data transferring unit 142, and a third data transferring unit 143.

The first data transferring unit 141 transfers data when the area indicated by the address has the burst-transferable attribute. When the write request is input, the first data transferring unit 141 writes write data corresponding to the write request to the buffer memory 150. The buffer memory 150a, 150b, or 150c to which data is written is determined in accordance with the processor information included in control information. More specifically, data is written to the buffer memory corresponding to the processor which has issued the write request. When the read request is input, the first data transferring unit 141 reads read data, corresponding to the read request, from the main memory 20, and outputs the read data to the processor 10.

The second data transferring unit 142 transfers data when the area indicated by the address has the non-burst-transferable attribute. When the write request is input, the second data transferring unit 142 writes write data corresponding to the write request to the main memory 20. When the read request is input, the second data transferring unit 142 reads, from the main memory 20, the read data corresponding to the read request, and outputs the read data to the processor 10.

The third data transferring unit 143 transfers data when the area indicated by the address has the cacheable attribute.

When the write request is input, write destination of the write data is different depending on whether the third data transferring unit 143 performs a write-back operation or a write-through operation.

When the write-back operation is performed, the third data transferring unit 143 determines whether the write request is a hit or a miss. When the write request is a hit, the write data is written to the cache memory 160. When the write request is a miss, the third data transferring unit 143 writes the address (tag address) included in the write request and write data to the cache memory 160. In any cases, the write data written to the cache memory 160 is written to the main memory 20 at a given timing.

When the write-through operation is performed, the third data transferring unit 143 determines whether the write request is a hit or a miss. When the write request is a hit, the third data transferring unit 143 writes the write address and write data to the buffer memory 150. The write data written to the buffer memory 150 is burst written to the cache memory 160 and the main memory 20 from the buffer memory 150 under the control of the control unit 130, when the determining unit 120 determines that the type of the subsequent memory access request meets the conditions.

When the write request is a miss, the third data transferring unit 143 also writes the write address and write data to the buffer memory 150 in the similar manner. The write data and write address written to the buffer memory 150 are burst written to the cache memory 160 and the main memory 20 from the buffer memory 150, when the determining unit 120 determines that the type of the subsequent memory access request meets the conditions.

When the read request is input, the third data transferring unit 143 determines whether the read request is a hit or a miss. When the read request is a hit, the third data transferring unit 143 reads the read data from the cache memory 160, and outputs the data to the processor 10.

When the read request is a miss, the third data transferring unit 143 reads the read data from the main memory 20, and writes the read data and read address to the cache memory 160. The third data transferring unit 143 then reads the read data from the cache memory 160 and outputs the data to the processor 10. The read data read from the main memory 20 may be output to the processor 10 at the same time as writing to the cache memory 160.

The buffer memories 150a, 150b, and 150c respectively correspond to the processors 10a, 10b, and 10c, and are store buffers (STB) which hold write data corresponding to the write request issued by a corresponding processor. The buffer memory 150 is a buffer memory which temporarily holds write data so as to merge the write data output from the processors 10.

In the embodiment, the buffer memory 150 is provided for each physical processor. As an example, the buffer memory 150 is capable of holding data of 128 bytes at maximum. The data held in the buffer memory 150 is burst written to the main memory 20 under the control of the control unit 130. In the case where the write request is an access to an area which has the cacheable attribute and where a write-through operation is performed, the data held in the buffer memory 150 is burst written to the main memory 20 and the cache memory 160.

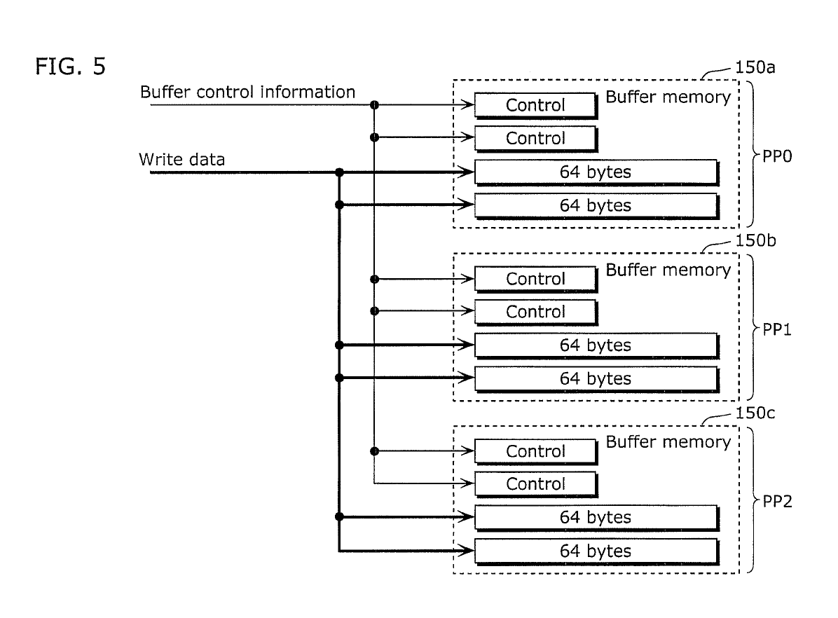

Here, reference is made to FIG. 5. FIG. 5 is a diagram schematically illustrating the buffer memories 150 included in the buffer memory device 100 according to the embodiment.

As shown in FIG. 5, the buffer memories 150a, 150b, and 150c are respectively provided for the physical processors (processors 10a (PP0), 10b (PP1), and 10c (PP2)). In other words, the buffer memory 150a holds buffer control information such as the write address output from the processor 10a and write data. The buffer memory 150b holds buffer control information such as the write address output from the processor 10b and write data. The buffer memory 150c holds buffer control information such as the write address output from the processor 10c and write data.

The buffer control information is information included in a write request, and is information for managing data to be written to the buffer memory 150. More specifically, the buffer control information includes at least a write address, and includes information indicating the physical processor and logical processor which have outputted corresponding write data.

In the example shown in FIG. 5, the buffer memory provided for each physical processor includes two areas each of which can hold data of 64 bytes. For example, these two areas may be associated with respective threads.

The cache memory 160 is, for example, a four-way set associative cache memory, and includes four ways each having a plurality of cache entries (for example, 16 cache entries). Each cache entry is an area for holding data of predetermined bytes (for example, 128 bytes). Each cache entry includes a valid flag, a tag address, line data, and a dirty flag.

The valid flag refers to a flag indicating whether or not the data of the cache entry is valid. The tag address refers to an address indicating write destination of data or read destination of data. The line data refers to a copy of data of predetermined bytes (for example, 128 bytes) in a block specified by the tag address and a set index. The dirty flag refers to a flag indicating whether or not it is necessary to write back the cached data into the main memory.

The associativity of the cache memory 160, that is, the number of ways included in the cache memory 160 is not limited to four, but may be any values. The number of cache entries in one way and the number of bytes of line data of one cache entry are also not limitative. The cache memory 160 may be any other types of cache memory. For example, it may be a direct mapped cache memory or a fully associative cache memory.

Here, reference is made to the conditions used for determination processing performed by the determining unit 120. In order to efficiently transfer the merged data to the buffer memory and to maintain data coherency, conditions for determining when to drain data are required.

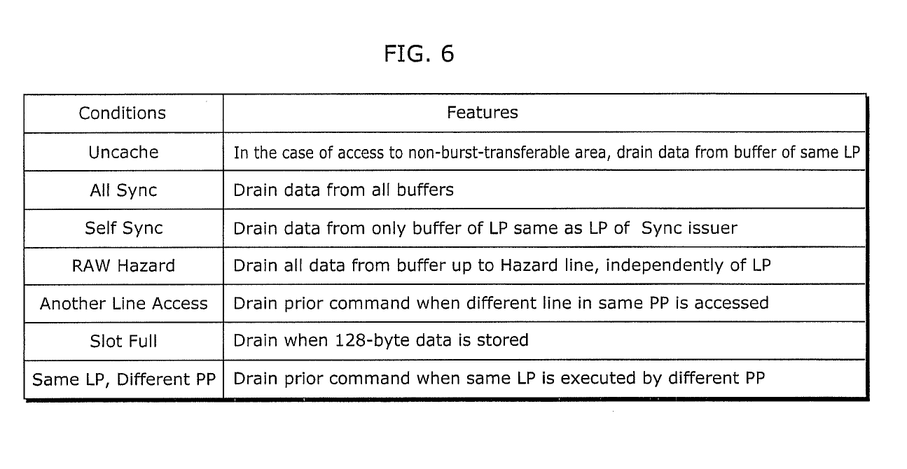

FIG. 6 is a diagram of a determination table showing examples of determining conditions according to the embodiment. In FIG. 6, the following conditions are shown as examples: attribute determining condition (“Uncache”); command determining condition (“All Sync” and “Self Sync”); address determining condition (“RAW Hazard” and “Another Line Access”); buffer amount determining condition (“Slot Full”); and processor determining condition (“same LP, different LP”).

The attribute determining condition is a condition for determining, using the attribute information, whether to drain data from the buffer memory 150 and the buffer memory which drains data, in accordance with the attribute of the area indicated by the address included in the memory access request. The condition “Uncache” shown in FIG. 6 is an example of the attribute determining condition.

The condition “Ucache” is used by the determining unit 120 for determining whether or not the attribute of the area indicated by the address included in the memory access request is non-burst-transferable. When determined as non-burst-transferable, the control unit 130 drains data from the buffer memory to the main memory 20. The data drained here corresponds to the memory access request issued by the logical processor same as the logical processor which has issued the memory access request. As a criteria of determination of the buffer memory which drains data, the control unit 130 may use a virtual processor which corresponds to a thread, instead of the logical processor.

The command determining condition is a condition for determining, using the command information, whether to drain data from the buffer memory 150 and the buffer memory which drains data, in accordance with the command included in the memory access request. The conditions “All Sync” and “Self Sync” shown in FIG. 6 are examples of the command determining condition.

The condition “All Sync” is used by the determining unit 120 for determining whether or not the memory access request includes the “All Sync” command. The “All Sync” command is a command for draining, to the main memory 20, all data held in all of the buffer memories 150. When the “All Sync” command is included (for example, the memory access information 201 in FIG. 4), the control unit 130 drains, to the main memory 20, all data held in all of the buffer memories 150.

The condition “Self Sync” is used by the determining unit 120 for determining whether or not the memory access request includes the “Self Sync” command. The “Self Sync” command is a command for draining, from the buffer memory 150 to the main memory 20, only the data output from the processor which has issued the command. When the “Self Sync” command is included (for example, the memory access information 202 in FIG. 4), the control unit 130 drains data from the buffer memory to the main memory 20. The data drained here corresponds to the memory access request issued by the logical processor same as the logical processor which has issued the memory access request. As a criteria of determination of the buffer memory which drains data, the control unit 130 may use a virtual processor which corresponds to a thread, instead of the logical processor.

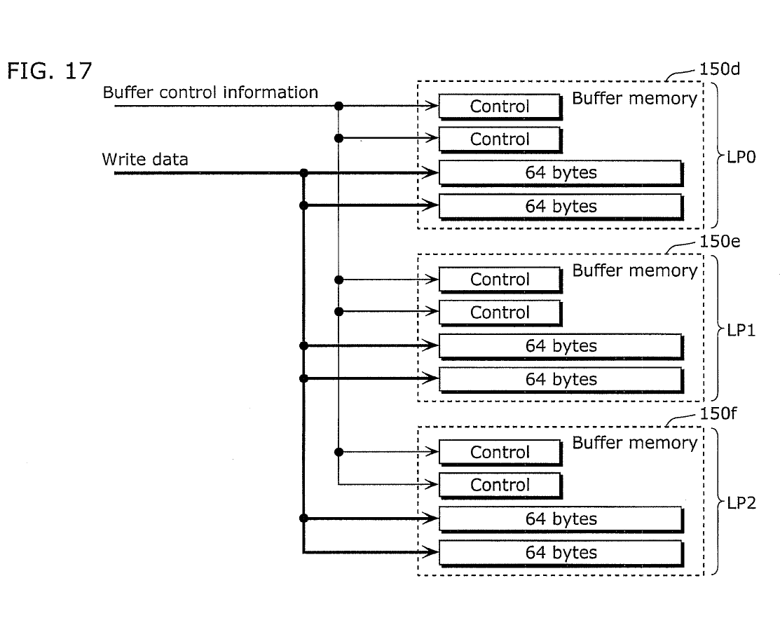

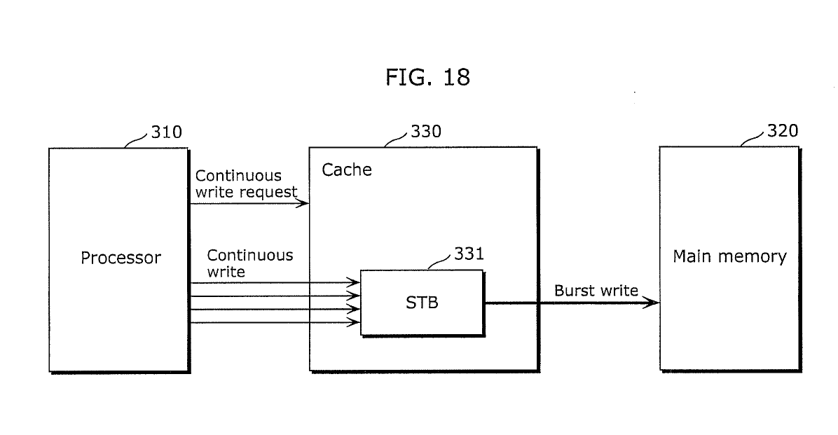

The address determining condition is a condition for determining, using address information, whether to drain data from the buffer memory 150 and the buffer memory which drains data, in accordance with the address included in the memory access request. The conditions “RAW Hazard” and “Another Line Access” shown in FIG. 17 are examples of the address determining condition.

The condition “RAW Hazard” is used by the determining unit 120 for determining whether or not the write address which matches the read address included in the read request is held in at least one of the buffer memories 150. When the write address which matches the read address is held in one of the buffer memories 150, the control unit 130 drains all data up to the Hazard line to the main memory 20. More specifically, the control unit 430 drains the data held in the buffer memory 150 prior to the write data corresponding to the write address.

The condition “Another Line Access” is used by the determining unit 120 for determining whether or not the write address included in the write request is related to the write address included in the immediately prior write request. More specifically, it is determined whether or not the two write addresses are continuous. Here, it is assumed that the two write requests are issued by the same physical processor. When determined that the two write addresses are not continuous, the control unit 130 drains, to the main memory 20, the data held in the buffer memory 150 prior to the write data corresponding to the immediately prior write request.

The buffer amount determining condition is a condition for determining, using the buffer amount information, whether to drain data from the buffer memory 150 and the buffer memory which drains data, in accordance with the data amount held in the buffer memory 150. The condition “Slot Full” shown in FIG. 6 is an example of the buffer amount determining condition.

The condition “Slot Full” is used by the determining unit 120 for determining whether or not the buffer amount that is the amount of data held in the buffer memory 150 is full (128 bytes). When determined that the buffer amount is 128 bytes, the control unit 130 drains the data in the buffer memory to the main memory 20.

The processor determining condition is a condition for determining, using the processor information, whether to drain data from the buffer memory 150, and the buffer memory which drains data, in accordance with the logical processor and the physical processor which have issued the memory access request. The condition “same LP, different PP” shown in FIG. 6 is an example of the processor determining condition.

The condition “same LP, different PP” is used for determining whether or not the logical processor which has issued the memory access request is the same as the logical processor which issued the write request corresponding to the write data held in the buffer memory 150. Furthermore, it is determined whether or not the physical processor which has issued the memory access request is different from the physical processor which has issued the write request. More specifically, the determining unit 120 determines whether or not at least one of the buffer memories holds write data that corresponds to the write request issued previously by the physical processor that is different from the physical processor indicated by the processor information and the logical processor that is the same as the logical processor indicated by the processor information. When determined that the logical processor is the same and the physical processor is different, the control unit 130 drains, from the buffer memory 150, data corresponding to the write request previously issued by the logical processor. It may be that whether or not the thread is the same is determined, instead of the logical processor.

As described, in the embodiment, data is drained from the buffer memory 150 when the respective conditions are met. Note that it is not necessary that all of the described conditions are met. Furthermore, a different condition may be added to the above conditions, or a different condition may be replaced with the above conditions.

For example, the condition “Slot Full” is a condition for determining whether or not the buffer amount is full. Instead of this condition, a condition may be used for determining whether or not a predetermined buffer amount (for example, half of the maximum value of the buffer amount that can be held in the buffer memory) is reached. For example, the maximum amount of data that can be held in the buffer memory 150 is 128 bytes. In the case where the data bus width between the buffer memory 150 and the main memory 20 is 64 bytes, it may be determined whether or not the buffer amount reaches 64 bytes.

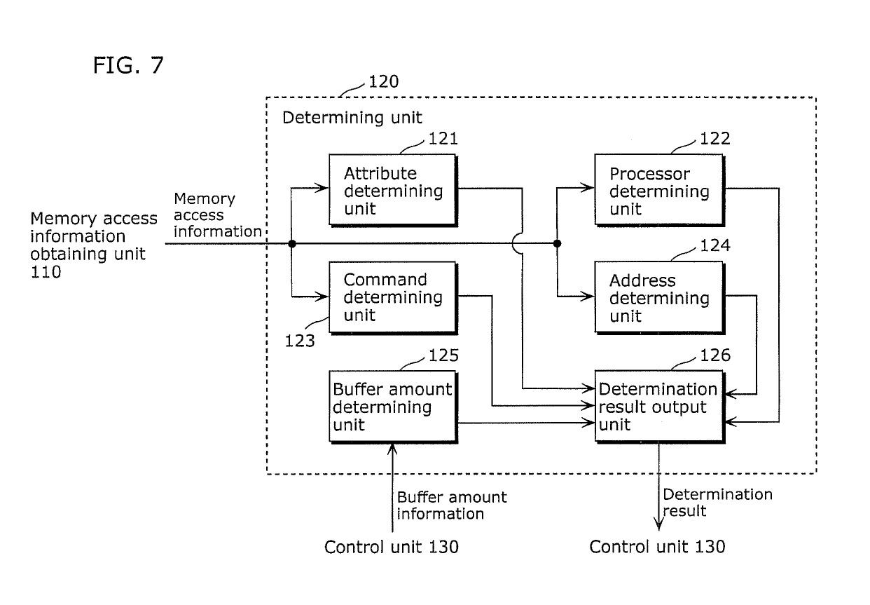

Here, reference is made to FIG. 7. FIG. 7 is a block diagram illustrating a detailed structure of the determination unit 120 according to the embodiment. As shown in FIG. 7, the determining unit 120 includes an attribute determining unit 121, a processor determining unit 122, a command determining unit 123, an address determining unit 124, a buffer amount determining unit 125, and a determination result output unit 126.

The attribute determining unit 121 obtains attribute information from the memory access information obtained by the memory access information obtaining unit 110, and determines the attribute of the area indicated by the address included in the memory access request from among the cacheable, burst-transferable, and non-burst-transferable attribute. The attribute determining unit 121 outputs the obtained determination result to the determination result output unit 126.

The processor determining unit 122 obtains processor information from the memory access information obtained by the memory access information obtaining unit 110, and determines the logical processor and the physical processor which have issued the memory access request from among logical processors and physical processors. The processor determining unit 122 outputs the obtained determination result to the determination result output unit 126.

The command determining unit 123 obtains command information from the memory access information obtained by the memory access information obtaining unit 110, and determines whether or not the memory access request includes one or more predetermined commands. Furthermore, the command determining unit 123 determines the type of the predetermined command, when the memory access request includes the predetermined command. The command determining unit 123 outputs the obtained determination result to the determination result output unit 126.

The predetermined command is, for example, a command for draining data from the buffer memory 150 independently of other conditions. Examples of the predetermined command include the “All Sync” command and “Self Sync” command.

The address determining unit 124 obtains address information from the memory access information obtained by the memory access information obtaining unit 110, and determines whether or not the address included in the memory access request is already held in the buffer memory 150. The address determining unit 124 further determines whether or not the address included in the memory access request is related to the address included in the immediately prior memory access request. More specifically, it is determined whether or not two addresses are continuous. The address determining unit 124 outputs the obtained determination result to the determination result output unit 126.

The buffer amount determining unit 125 obtains the buffer amount from the buffer memory 150 via the control unit 130, and determines, for each buffer memory, whether or not the buffer amount reaches a predetermined threshold. The buffer amount determining unit 125 outputs the obtained determination result to the determination result output unit 126. Examples of the predetermined threshold include the maximum value of the buffer memory 150, or the data bus width between the buffer memory device 100 and the main memory 20.

The determination result output unit 126 determines whether the conditions shown in FIG. 6 are met, based on the determination results input from the respective determining units, and outputs the obtained determination result to the control unit 130. More specifically, when determined that the conditions shown in FIG. 6 are met, the determination result output unit 126 outputs, to the control unit 130, drain information indicating which data in which buffer memory is to be drained to the main memory 20.

According to the above structure, the buffer memory device 100 according to the embodiment includes a plurality of buffer memories 150 which temporarily hold write data output from a plurality of processors 10, and when predetermined conditions are met, performs a burst write of data held in the buffer memory 150 to the main memory 20. More specifically, in order to merge small-size write data, the write data is temporarily held in the buffer memory 150, and the large-size data obtained by the merge is burst written to the main memory 20. Here, it is determined whether or not the data is drained from the buffer memory 150, based on a condition for guaranteeing the order of data between the processors.

Accordingly, efficiency of data transfer can be increased while maintaining data coherency.

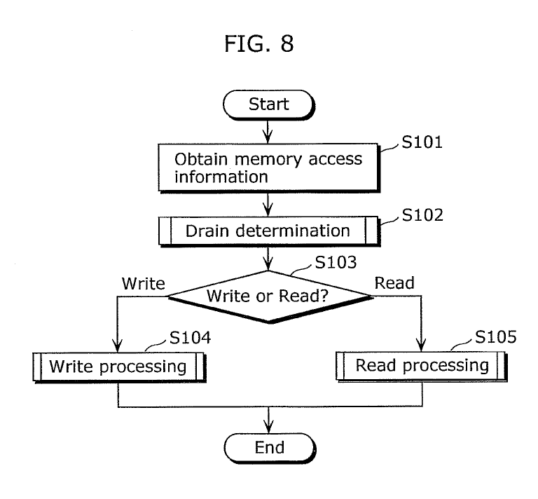

Next, reference is made to the operations of the buffer memory device 100 according to the embodiment, with reference to FIGS. 8 to 16. FIG. 8 is a flowchart of the operations of the buffer memory device 100 according to the embodiment.

First, the buffer memory device 100 according to the embodiment executes data transfer according to the embodiment, upon receipt of a memory access request from the processor 10.

The memory access information obtaining unit 110 obtains memory access information from the memory access request (S101). The obtained memory access information is output to the determining unit 120. The determining unit 120 obtains buffer amount information from the buffer memory 150 via the control unit 130 as necessary.

The determining unit 120 determines whether or not data is to be drained from the buffer memory 150, based on the received memory access information and the obtained buffer amount information (S102). Detailed description of the drain determination will be given later.

The command determining unit 123 then determines whether the memory access request is a write request or a read request (S103). When the memory access request is a write request (“Write” in S103), the data transferring unit 140 performs write processing of write data output from the processor 10 (S104). When the memory access request is a read request (“Read” in S103), the data transferring unit 140 executes read processing of read data to the processor 10 (S105).

In the case where it is determined in the drain determination processing (S102) whether the memory access request is a write request or a read request, write processing (S104) or read processing (S105) may be executed after the drain determination processing (S102) without determination processing of the memory access request (S603).

In the following, first, details of the write processing (S104) and read processing (S105) are given.

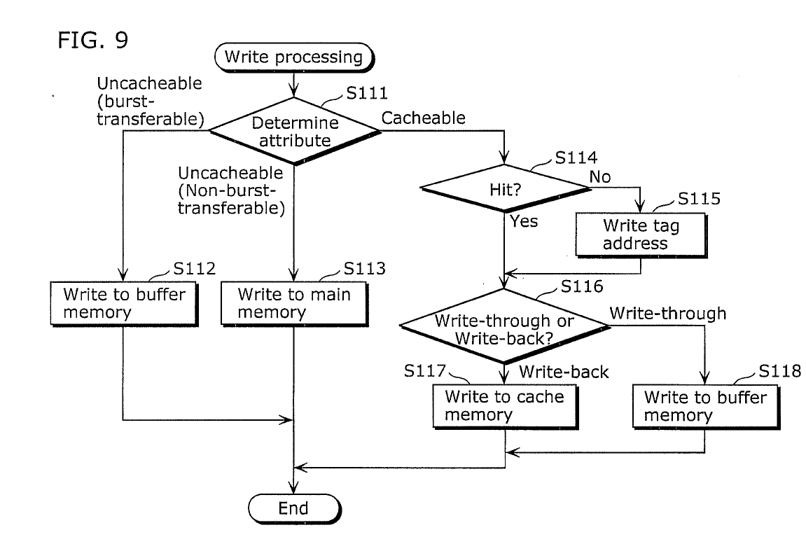

FIG. 9 is a flowchart of the write processing of the buffer memory device 100 according to the embodiment.

When the memory access request is a write request, first, the attribute determining unit 121 first determines the attribute of the area indicated by the write address included in the write request (S111). More specifically, the attribute determining unit 121 determines the attribute of the area indicated by the write address from among the burst-transferable, non-burst-transferable and cacheable attribute.

When determined that the attribute of the area indicated by the write address is burst-transferable (“uncacheable (burst-transferable)” in S111), the first data transferring unit 141 writes write data output from the processor 10 to the buffer memory 150 (S112). More specifically, the first data transferring unit 141 writes write data to the buffer memory (for example, buffer memory 150a) corresponding to the physical processor that has issued the write request (processor 10a), under the control of the control unit 130.

When determined that the attribute of the area indicated by the write address is non-burst-transferable (“uncacheable (non-burst-transferable)” in S111), the second data transferring unit 142 writes, to the main memory 20, the write data output from the processor 10 (S113).

When determined that the attribute of the area indicated by the write address is cacheable (“cacheable” in S111), the third data transferring unit 143 determines whether the write request is a hit or a miss (S114). When the write request is a miss (No in S114), the third data transferring unit 143 write a tag address to the cache memory 160 (S115).

After writing of the tag address, or when the write request is a hit (Yes in S114), the control unit 130 changes the writing destination of the write data depending on whether the write processing based on the write request is a write-back operation or a write-through operation (S117). In the case of the write-back operation (“write-back” in S116), the third data transferring unit 143 writes write data to the cache memory 160 (S117). In the case of the write-through operation (“write-through” in S116), the third data transferring unit 143 writes write data and write address to the buffer memory 150 (S118).

In such a manner, the write data output from the processor 10 is written to the main memory 20, the buffer memory 150, or the cache memory 160. The data written to the buffer memory 150 or the cache memory 160 is written to the main memory 20 by the drain determination processing executed when the subsequent access request is input or the like.

In the case where the attribute of the area indicated by the write address is determined in the drain determining processing (S102), respective write processing may be executed after the determination processing of the memory access request (S103) without the attribute determination processing (S111).

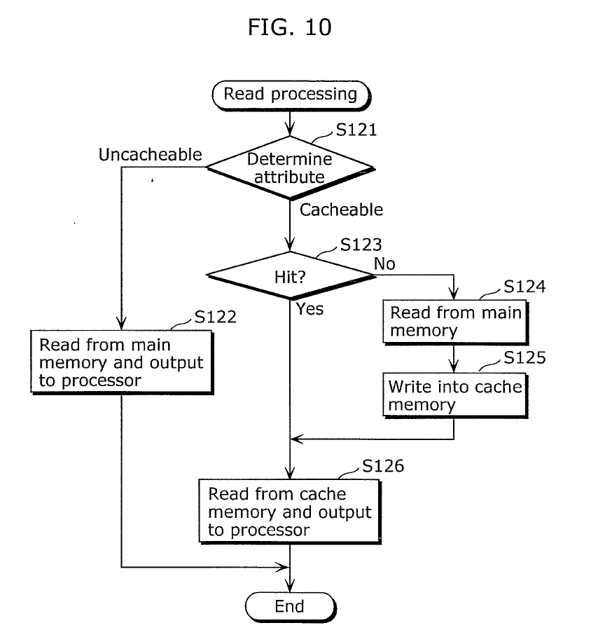

FIG. 10 is a flowchart of the read processing of the buffer memory device 100 according to the embodiment.

When the memory access request is a read request, first, the attribute determining unit 121 determines the attribute of the area indicated by the read address included in the read request (S121). More specifically, the attribute determining unit 121 determines whether the attribute of the area indicated by the read address is cacheable or uncacheable.

When determined that the attribute of the area indicated by the read address is uncacheable (“uncacheable” in S121), the first data transferring unit 141 or the second data transferring unit 142 reads the read data corresponding to the read request from the main memory 20, and outputs the data to the processor 10 (S122).

When determined that the attribute of the area indicated by the read address is cacheable (“cacheable” in S121), the third data transferring unit 143 determines whether the read request is a hit or a miss (S123) When the read request is a miss (No in S123), the third data transferring unit 143 reads, from the main memory 20, the read data corresponding to the read request (S124). The read data and the read address (tag address) are written to the cache memory 160 (S125). The third data transferring unit 143 then reads the read data from the cache memory 160, and outputs the data to the processor 10 (S126). Here, the writing of the read data into the cache memory 160 may be executed at the same time as the output to the processor 10.

When the read request is a hit (Yes in S123), the third data transferring unit 143 reads the read data from the cache memory 160, and outputs the data to the processor 10 (S126).

In such a manner, the buffer memory device 100 reads read data from the cache memory 160 or the main memory 20, and outputs the data to the processor 10, in accordance with the read request issued by the processor 10.

In the case where the attribute of the area indicated by the read address is determined in the drain determination processing (S102), respective read processing may be executed after the determination processing of the memory access request (S103), without the attribute determination processing (S121).

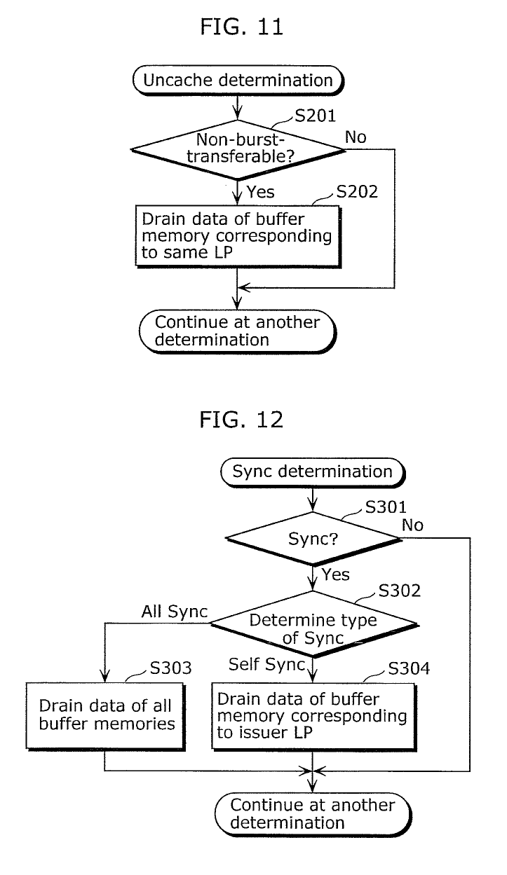

Next, details of the drain determination processing (S102) are given with reference to FIGS. 11 to 16. In the drain determination processing, the conditions indicated in the determination table shown in FIG. 6 may be determined in any order. However, it is preferable to preferentially execute a condition which eliminates the need for subsequent determination of the other conditions. Example of such condition include the condition “All Sync” in which data held in all buffers is drained when the condition is met.

FIG. 11 is a flowchart of the attribute determination processing of the buffer memory device 100 according to the embodiment. FIG. 11 shows the details of the drain determination processing based on the condition “Uncache” in FIG. 6.

When the determining unit 120 receives the memory access information, the attribute determining unit 121 determines whether or not the attribute of the area indicated by the address included in the memory access request is non-burst-transferable (S201). When the attribute of the area indicated by the address is not non-burst-transferable (No in S201), another determination processing is executed.

When determined that the attribute of the area indicated by the address included in the memory access request is non-burst-transferable (Yes in S201), the control unit 130 drains data from the buffer memory to the main memory 20. The data drained here corresponds to the memory access request issued by the logical processor same as the logical processor that has issued the memory access request (S202). The control unit 130 executes data drain by identifying the buffer memory which drains data from among the buffer memories 150, based on the determination result of the processor determining unit 122. After the draining, another determination processing is executed.

FIG. 12 is a flowchart of the command determination processing of the buffer memory device 100 according to the embodiment. FIG. 12 shows the drain determination processing based on the conditions “All Sync” and “Self Sync” in FIG. 6.

When the determining unit 120 receives the memory access information, the command determining unit 123 determines whether the command included in the memory access request includes the “Sync” command that is a command for draining data independently of the other conditions (S301). When the memory access request does not include the “Sync” command (No in S301), another determination processing is executed.

When the memory access request includes the “Sync” command (Yes in S301), the command determining unit 123 determines whether the “Sync” command is the “All Sync” command or “Self Sync” command (S302). When the “Sync” command is the “All Sync” command (“All Sync” in S302), the control unit 130 drains all data from all of the buffer memories 150 (S303).

When the “Sync” command is the “Self Sync” command (“Self Sync” in S302), the control unit 130 drains data from the buffer memory to the main memory 20. The data drained here corresponds to the memory access request issued by the logical processor same as the logical processor that has issued the memory access request (S304). The control unit 130 executes data drain by identifying the buffer memory which drains data, from among the buffer memories 150, based on the determination result of the processor determining unit 122.

After the data drain, another determination processing is executed.

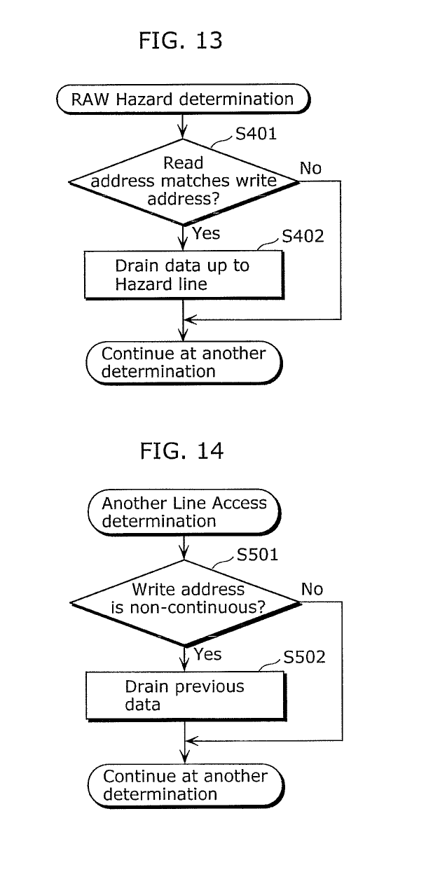

FIG. 13 is a flowchart of the read address determination processing of the buffer memory device 100 according to the embodiment. FIG. 13 shows the drain determination processing based on the condition “RAW Hazard” in FIG. 6. The condition “RAW Hazard” is a condition used when the buffer memory device 100 receives a read request. In other words, when the command determining unit 123 determines that the memory access request is a read request, the condition “RAW Hazard is used.

The address determining unit 124 determines whether or not the read address included in the read request matches the write address held in the buffer memory 150 (S401). When determined that the read address does not match the write address held in the buffer memory 150 (No in S401), another determination processing is executed.

When determined that the read address matches the write address held in the buffer memory 150 (Yes in S401), the control unit 130 drains, from the buffer memory 150, all of data up to the Hazard line, that is, all of the data held prior to the write data corresponding to the matched write address (S402). After the data drain, another determination processing is executed.

FIG. 14 is a flowchart of the write address determination processing of the buffer memory device 100 according to the embodiment. FIG. 14 shows the drain determination processing based on the condition “Another Line Access” in FIG. 6. The condition “Another Line Access” is a condition used when the buffer memory device 100 receives a write request. In other words, when the command determining unit 123 determines that the memory access request is a write request, the condition “Another Line Access” is used.

The address determining unit 124 determines whether or not the write address included in the write request is continuous with the write address included in the immediately prior write request (S501). When the two addresses are continuous (No in S501), another determination processing is executed.

When the two addresses are not continuous (Yes in S501), the control unit 130 drains the write data corresponding to the immediately prior write request, and all the prior data from the buffer memory 150 (S502). After the data drain, another determination processing is executed.

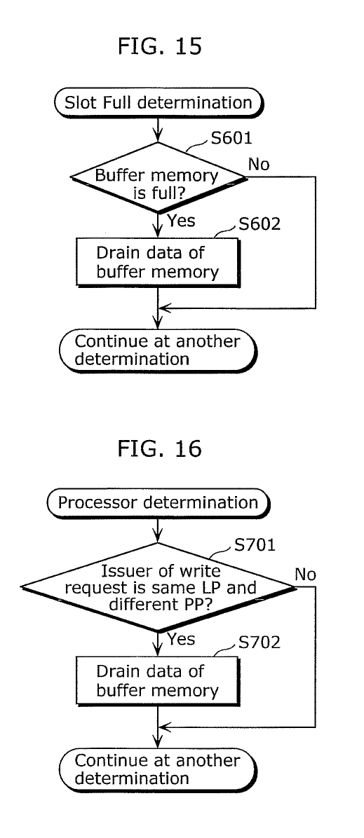

FIG. 15 is a flowchart of the buffer amount determination processing of the buffer memory device 100 according to the embodiment. FIG. 15 shows the drain determination processing based on the condition “Slot Full” in FIG. 6.

The condition “Slot Full” is different from the other conditions, and is a condition determined based on not the memory access information, but the buffer amount information obtained from the buffer memory 150. Thus, the condition “Slot Full” may be used only when the buffer memory device 100 receives a memory access request but also at any timings or when data is written to the buffer memory 150.

The buffer amount determining unit 125 obtains buffer amount information from the buffer memory 150 via the control unit 130, and determines, for each buffer memory, whether or not the buffer amount is full (S601). In the case where the buffer amount is not full (No in S601), another determination processing is executed when the buffer memory device 100 receives the memory access request.

When the buffer amount is full (Yes in S601), the control unit 130 drains data from the buffer memory having full buffer amount among the buffer memories 150 (S602). After the data drain, another determination processing is executed.

FIG. 16 is a flowchart of the processor determination processing of the buffer memory device 100 according to the embodiment. FIG. 16 shows the drain determination processing based on the condition “same LP, different PP” in FIG. 6.

When the determining unit 120 receives memory access information, the processor determining unit 122 determines whether the buffer memory 150 holds write data corresponding to the memory access request that is previously issued by the logical processor that is the same as the logical processor that has issued the memory access request and a physical processor that is different from the physical processor that has issued the memory access request (S701).

When the write data is not held in the buffer memory 150 (No in S701), another determination processing is executed.

When the buffer memory 150 holds the write data output from the same logical processor and different physical processor (Yes in S701), the data is drained from the buffer memory which holds the write data (S702). After the data drain, another determination processing is executed.

After the determination processing shown in FIGS. 11 to 16, the drain determination processing (S102 in FIG. 8) ends.

When the conditions used in the drain determination processing are not met, the write data corresponding to the write request is held in the buffer memory 150. In other words, the input small-size write data is merged in the buffer memory 150 to be large-size data. The data is burst written to the main memory 20 when any of the conditions is met.

In the above description, data is drained to the main memory 20 each time respective determination conditions are met; however, after all of the determination of the conditions, data corresponding to the met conditions may be collectively drained to the main memory 20.

As described, the buffer memory device 100 according to the embodiment includes the buffer memory 150 provided for each processors 10. Each buffer memory 150 merges the write data output from the processor 10 for storage. When one or more predetermined conditions are met, the merged data is burst written to the main memory from the buffer memory 150.

Accordingly, the large-size data obtained by merging small-size write data can be burst written to the main memory 20; and thus, efficiency of data transfer can be increased compared to the case where small-size data is separately written. Furthermore, by including conditions for reading data from the buffer memory 150, coherency between write data output from a plurality of processors can be maintained. In particular, by draining data held in the buffer memory 150 in the case where the memory access request is issued by the logical processor, but the different physical processor, data coherency can be maintained even in the case of the multi-threading executed by a plurality of processors, or a memory system using a multi-processor.

The buffer memory device and the data transfer method according to the present invention have been described based on the embodiment; however, the present invention is not limited to the embodiment. Those skilled in the art will readily appreciate that many modifications are possible in the exemplary embodiment without materially departing from the novel teachings and advantages of this invention. Accordingly, all such modifications are intended to be included within the scope of this invention.

For example, the buffer memory device 100 according to the embodiment includes a buffer memory 150 for each of physical processors. It may be that the buffer memory device 100 includes a buffer memory for each of logical processors.

FIG. 17 is another diagram schematically illustrating the buffer memories 150 included in the buffer memory device 100 according to the embodiment. The buffer memories 150d, 150e, and 150f shown in FIG. 17 respectively correspond to the logical processors LP0, LP1, and LP2. More specifically, the buffer memories 150d, 150e, and 150f hold buffer control information and write data corresponding to the write request respectively issued by the logical processors LP0, LP1, and LP2.

It may also be that the buffer memory device 100 includes a buffer memory for each set of a logical processor and a physical processor.

It also may be that the buffer memory device 100 includes a buffer memory 150 for each of virtual processors corresponding to respective threads. It may also be that the buffer memories 150 are physically different memories, or virtual memories which correspond to a plurality of areas virtually divided from one physical memory.

The buffer memory device 100 according to the embodiment performs, for writing to the cache memory 160 by a write-through operation, a burst write of the merged data by using the buffer memory 150; however, the buffer memory 150 does not always need to be used. In other words, the third data transferring unit 143 may directly write, to the cache memory 160, write data corresponding to a write request.

In the embodiment, of the write processing into the main memory 20 which is divided into the cacheable, burst-transferable, and non-burst-transferable attributes, the buffer memory 150 is used for the write processing to the non-burst-transferable area and the cacheable area (write-through operation). It also may be that the buffer memory is used for the write processing to the main memory 20 divided into the cacheable and uncacheable attributes. More specifically, the uncacheable area of the main memory 20 does not need to be divided into the burst-transferable area and the non-burst-transferable area. However, as described above, the uncacheable area may include a read sensitive area, it is preferable to divide the main memory 20 into the burst-transferable and non-burst-transferable areas.

At the time of writing data from the processor 10 to the main memory 20, the buffer memory device 100 according to the embodiment temporarily holds data and performs a burst write of the held data, so as to increase data transfer efficiency. It may also be that a separate buffer memory (prefetch buffer (PFB) dedicated for reading is included so that the data is burst read from the main memory 20 and the burst read data is temporarily held in the PFB. This allows increased data transfer efficiency at the time of reading, too.

As shown in FIG. 4, the buffer memory device 100 according to the embodiment has been described using the example case where the “Sync” command is attached to the memory access request issued by the processor 10; however, it may be that the “Sync” command is not attached to the memory access request. For example, it may be that the buffer memory device 100 includes an I/O mapped register, and when the processor 10 accesses the register, data is drained from a corresponding buffer memory 150.

The present invention may also be implemented as a memory system including the buffer memory device 100, the processor 10, and the main memory 20 according to the embodiment. Here, the issuer of the memory access request may be a processor such as a CUP, or any masters such as a direct memory access controller (DMAC).

The embodiment has been described where the L2 cache 40 includes the buffer memory 150; however, the L1 cache 30 may include the buffer memory 150. Here, it may be that the memory system does not include the L2 cache 40.

Furthermore, the present invention may be applied to the memory system including a cache higher than the level 3 cache. In this case, it is preferable that the highest level cache includes the buffer memory 150.

As described, the present invention can be implemented not only as a buffer memory device, a memory system, and a data transfer method, but also as a program causing a computer to execute the data transfer method according to the embodiment. The present invention may also be implemented as a recording medium such as a computer-readable CD-ROM which stores the program. The present invention may also be implemented as information, data, or a signal indicating the program. Such program, information, data and signal may be distributed via a communication network such as the Internet.

In addition, part or all of the elements of the buffer memory device may include a single system Large Scale Integration (LSI). The system LSI, which is a super-multifunctional LSI manufactured by integrating elements on a single chip, is specifically a computer system which includes a microprocessor, a ROM, a RAM and the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The buffer memory device and the memory system according to the present invention may be used in a system where data is transferred between a processor such as a CPU and a main memory. For example, the present invention may be applied to a computer.

What is claimed is:

1. A buffer memory device which transfers data between a plurality of processors and a main memory in response to a memory access request including a write request or a read request issued by each of the processors, said buffer memory device comprising:
a plurality of buffer memories each of which is provided for a corresponding one of the processors, and holds write data corresponding to the write request issued by the corresponding one of the processors;
a memory access information obtaining unit configured to obtain memory access information indicating a type of the memory access request;
a determining unit configured to determine whether or not the type indicated by the memory access information obtained by said memory access information obtaining unit meets a predetermined condition; and
a control unit configured to drain data held in a buffer memory to the main memory, when said determining unit determines that the type indicated by the memory access information meets the predetermined condition, the buffer memory being included in said buffer memories and meeting the predetermined condition.

2. The buffer memory device according to claim 1,
wherein the processors are a plurality of physical processors,
each of said buffer memories is provided for a corresponding one of the physical processors, and holds write data corresponding to the write request issued by the corresponding one of the physical processors,
said memory access information obtaining unit is configured to obtain, as the memory access information, processor information indicating a logical processor and a physical processor which have issued the memory access request,
said determining unit is configured to determine that the predetermined condition is met, in the case where one of said buffer memories holds write data corresponding to a write request previously issued by (i) a physical processor that is different from the physical processor indicated by the processor information and (ii) a logical processor that is same as the logical processor indicated by the processor information, and
when said determining unit determines that the predetermined condition is met, said control unit is configured to drain, to the main memory, the data held in the buffer memory which meets the predetermined condition.

3. The buffer memory device according to claim 2,
wherein said determining unit is further configured to determine whether or not the memory access information includes command information for draining, to the main memory, data held in at least one of said buffer memories,
when said determining unit determines that the memory access information includes the command information, said control unit is further configured to drain, to the main memory, the data indicated by the command information and held in the at least one of said buffer memories.

4. The buffer memory device according to claim 3,
wherein the command information is information for draining, to the main memory, data held in all of said buffer memories, and
when said determining unit determines that the memory access information includes the command information, said control unit is further configured to drain, to the main memory, the data held in all of said buffer memories.

5. The buffer memory device according to claim 3,
wherein, when said determining unit determines that the memory access information includes the command information, said control unit is further configured to drain, to the main memory, data held in one of said buffer memories corresponding to a processor which has issued the memory access request.

6. The buffer memory device according to claim 2,
wherein the main memory includes a plurality of areas each having either a cacheable attribute or an uncacheable attribute,
said memory access information obtaining unit is further configured to obtain, as the memory access information, attribute information and processor information, the attribute information indicating an attribute of an area indicated by an address included in the memory access request, the processor information indicating a processor which has issued the memory access request,
said determining unit is further configured to determine whether or not the attribute indicated by the attribute information is the uncacheable attribute and a non-burst-transferable attribute which indicates that data to be burst transferred is to be held, and
when said determining unit determines that the attribute indicated by the attribute information is the non-burst-transferable attribute, said control unit is further configured to drain, to the main memory, data held in one of said buffer memories corresponding to the processor indicated by the processor information.

7. The buffer memory device according to claim 2,
wherein said buffer memories hold a write address corresponding to the write data,
when the memory access request includes the read request, said memory access information obtaining unit is further configured to obtain, as the memory access information, a read address included in the read request,
said determining unit is configured to determine whether or not a write address which matches the read address is held in at least one of said buffer memories, and
when said determining unit determines that the write address which matches the read address is held in the at least one of said buffer memories, said control unit is configured to drain, to the main memory, data held in said buffer memories prior to the write data corresponding to the write address.

8. The buffer memory device according to claim 2,
wherein, when the memory access request includes the write request, said memory access information obtaining unit is further configured to obtain a first write address included in the write request,
said determining unit is configured to determine whether or not the first write address is continuous with a second write address included in an immediately prior write request, and
when said determining unit determines that the first write address is continuous with the second write address, said control unit is configured to drain, to the main memory, data held in said buffer memories prior to write data corresponding to the second write address.

9. The buffer memory device according to claim 2,
wherein said determining unit is further configured to determine whether or not an amount of data held in each of said buffer memories reaches a predetermined threshold, and
when said determining unit determines that the data amount reaches the predetermined threshold, said control unit is further configured to drain, to the main memory, the data held in the buffer memory having the data amount which reaches the predetermined threshold.

10. The buffer memory device according to claim 2,
wherein the main memory includes a plurality of areas each having either a cacheable attribute or an uncacheable attribute,
said buffer memory device further comprises
a data writing unit configured to write, to said buffer memories, write data corresponding to the write request, when the attribute of the area indicated by the write address included in the write request is the uncacheable attribute and a non-burst-transferable attribute which indicates that data to be burst transferred is to be held, and
said buffer memories hold the write data written by said data writing unit.

11. The buffer memory device according to claim 10, further comprising a cache memory,
wherein (i) when the attribute of the area indicated by the write address is the cacheable attribute and (ii) when the write data corresponding to the write request is written to said cache memory and the main memory at the same time, said data writing unit is further configured to write the write data corresponding to the write request to said buffer memories, and
when said determining unit determines that the predetermined condition is met, said control unit is configured to drain the data held in the buffer memory which meets the predetermined condition to the main memory and said cache memory.

12. The buffer memory device according to claim 2,
wherein at least one of said buffer memories holds write addresses included in a plurality of said write requests, and write data corresponding to the respective write requests.

13. The buffer memory device according to claim 1,
wherein the processors are a plurality of logical processors, and
each of said buffer memories is provided for a corresponding one of the logical processors, and holds write data corresponding to the write request issued by the corresponding one of the logical processors.

14. The buffer memory device according to claim 1,
wherein the processors are a plurality of virtual processors corresponding to respective threads, and
each of said buffer memories is provided for a corresponding one of the virtual processors and holds write data corresponding to the write request issued by the corresponding one of the virtual processors.

15. A memory system in which data is transferred between a plurality of processors and a main memory in response to a memory access request issued by each of the processors, the memory access request including a write request and a read request, said memory system comprising:
the plurality of processors;
the main memory;
a plurality of buffer memories each of which is provided for a corresponding one of the processors and holds write data corresponding to the write request issued by the corresponding one of the processors,
a memory access information obtaining unit configured to obtain memory access information indicating a type of the memory access request,
a determining unit configured to determine whether or not the type indicated by the memory access information obtained by the memory access information obtaining unit meets a predetermined condition, and
a control unit configured to drain data held in a buffer memory to the main memory, when said determining unit determines that the type indicated by the memory access information meets the predetermined condition, the buffer memory being included in said buffer memories and meeting the predetermined condition.

16. A method of transferring data between a plurality of processors and a main memory in response to a memory access request issued by each of the processors, the memory access request including a write request and a read request, said method comprises:
obtaining memory access information indicating a type of the memory access request issued by each of the processors;
determining whether or not the type indicated by the memory access information obtained in said obtaining meets a predetermined condition; and
when determined in said determining that the type indicated by the memory access information meets the predetermined condition, draining, to the main memory, data held in a buffer memory that meets the predetermined condition, the buffer memory being included in a plurality of buffer memories each of which is provided for a corresponding one of the processors and holds write data corresponding to the write request issued by the corresponding one of the processors.
